(19) United States
(12) Patent Application Publication
(10) Pub. No.: US 2024/0326243 A1
(43) Pub. Date: Oct. 3, 2024

(54) AUTOMATION SYSTEM FOR PERFORMING LAB PROTOCOLS

(71) Applicant: Medra Inc., San Francisco, CA (US)

(72) Inventors: Michelle A. Lee, San Francisco, CA (US); Jamie Delton, San Francisco, CA (US); Albert Tung, San Francisco, CA (US); Thomas Randolph, San Francisco, CA (US); Russell Ohnemus, San Francisco, CA (US)

(21) Appl. No.: 18/622,571

(22) Filed: Mar. 29, 2024

Related U.S. Application Data
(60) Provisional application No. 63/493,682, filed on Mar. 31, 2023.

(51) Int. Cl. B25J 9/16; B01L 1/00; B25J 9/00; G01N 35/00

(52) U.S. Cl. CPC B25J 9/163; B01L 1/00; B25J 9/0081; B25J 9/1679; B25J 9/1697; G01N 35/0099

(57) ABSTRACT

An automation system includes a robotic arm with an end effector configured to learn from demonstrations. The automation system receives a demonstration of a lab protocol for operating a type of machine from a user and records a sequence of actions associated with operating the type of machine based on the demonstration. For each action, computer vision is used to derive information associated with the action. The automation system extracts semantic meanings of the action based in part on the information and generates a machine-executable protocol for operating the type of machine by a robot based in part on the semantic meanings of the actions. In some embodiments, the automation system further includes a closed-loop control subsystem that uses computer vision and/or other sensors (e.g., force torque sensors) to automatically maintain a desired state or set point associated with operation of the type of machine.

### CROSS-REFERENCE TO RELATED APPLICATIONS

This application claims the benefit of U.S. Provisional Application No. 63/493,682, filed Mar. 31, 2023, which is incorporated by reference in its entirety.

### BACKGROUND

This disclosure relates generally to automation systems and, more specifically, to artificial intelligence (AI)-powered automation systems for machine-tending tasks in lab environments.

Traditional machine-tending processes involve a variety of manual laboratory protocols performed by human operators. These protocols can vary widely depending on the machine type and specific operations, but they generally include loading materials or samples into the machine, setting it up for operation, monitoring the process, and unloading the machine upon completion.

In laboratory settings, different machines are utilized for different tasks, requiring human operators to adjust operational parameters like temperature, pressure, and speed. The preparation and loading of samples include measuring quantities, placing them into appropriate containers, such as tubes, and inserting these into the machines. Operators initiate machine operations by performing actions such as opening lids, loading samples, closing lids, and pressing start buttons. Throughout the operation, they monitor for malfunctions, ensure parameters are maintained, and assess the process's progress, making adjustments as necessary to achieve desired outcomes. Upon completion, operators collect end products from the machine, which might include opening the lid, removing samples, downloading data, or handling produced materials. Post-operation, the machine undergoes cleaning and maintenance as dictated by lab protocols, readying it for future use.

Because machine-tending in lab environments requires preparing samples and setting up the machine, including calibration, programming, collecting end products, and cleaning, it is labor-intensive, time-consuming, and challenging to automate.

### SUMMARY

Embodiments described herein relate to an automation system that includes a robotic arm with an end effector configured to learn from demonstrations. The automation system receives a demonstration of a lab protocol for operating a type of machine from a user and records a sequence of actions associated with operating the type of machine based on the demonstration. In some embodiments, the demonstration includes the user manually guiding the robotic arm to interact with the machine, such as (but not limited to) pressing a button, opening a lid of the machine, and/or picking up an object and placing it inside the machine. The machine may be (but is not limited to) a centrifuge, an ultra-low-temperature (ULT) freezer, an incubator, an automated tissue processor, or a spectrophotometer. In some embodiments, the end effector may include (but is not limited to) a robotic gripper, a pneumatic gripper, a cap opener, a single channel pipette, and/or a multichannel pipette.

In some embodiments, a camera is configured to capture images in the vicinity of the robotic arm or its end effector for each action. Computer vision analyzes these images to extract information related to the action. The automation system extracts semantic meanings of the action based in part on the information and generates a machine-executable protocol to enable the automation system to operate a specific type of machine. In some embodiments, the automation system further includes a closed-loop control subsystem that uses computer vision and/or other sensors (e.g., force torque sensors) to automatically maintain a desired state or set point for the machine.

### BRIEF DESCRIPTION OF THE DRAWINGS

FIG. 1 illustrates an example environment, in which an automation system may be implemented in accordance with one or more embodiments.

FIG. 2 illustrates an example architecture of an automation system in accordance with one or more embodiments.

FIG. 3 illustrates an example architecture of a controller in accordance with one or more embodiments.

FIG. 4 illustrates an example architecture of a client device in accordance with one or more embodiments.

FIG. 5 illustrates an example architecture of a central system in accordance with one or more embodiments.

FIG. 6 illustrates a perspective view of an example automation system in accordance with one or more embodiments.

FIG. 7A illustrates a robotic gripper end effector that includes multiple fingers in accordance with one or more embodiments.

FIG. 7B illustrates a pneumatic gripper end effector in accordance with one or more embodiments.

FIG. 7C illustrates a cap opener end effector configured to open a cap of a container in accordance with one or more embodiments.

FIG. 7D illustrates a multichannel pipette end effector configured to transfer precise volumes of samples in accordance with one or more embodiments.

FIG. 7E illustrates a pipette end effector configured to measure and transfer a precise volume of samples in accordance with one or more embodiments.

FIG. 7F illustrates a sensor end effector configured to detect or measure physical parameters in an environment in accordance with one or more embodiments.

FIG. 8A is an example of an ultra-low-temperature (ULT) freezer configured to maintain low temperatures, which may be operated by an automation system described herein in accordance with one or more embodiments.

FIG. 8B is an example of a centrifuge configured to separate substances of different densities within a liquid by spinning them at high speeds, which may be operated by an automation system described herein in accordance with one or more embodiments.

FIG. 8C is an example of a biosafety cabinet configured to provide a particulate-free environment and protect sensitive biological samples or cultures from contamination, which may be operated by an automation system described herein in accordance with one or more embodiments.

FIG. 8D is an example of microplate reader configured to capture visual data from microplates, which may be operated by an automation system described herein in accordance with one or more embodiments.

FIG. 8E is an example of a thermocycler configured to amplify segments of DNA through temperature cycling, which may be operated by an automation system described herein in accordance with one or more embodiments.

FIG. 9A illustrates an example embodiment in which a user demonstrates a laboratory protocol for operating a centrifuge to an automation system in accordance with one or more embodiments.

FIG. 9B illustrates the aftermath of the demonstration illustrated in FIG. 9A in which the automation system has learned the lab protocol for operating a centrifuge in accordance with one or more embodiments.

FIG. 9C illustrates an example environment in which the automation system is coupled to a serological pipette end effector and a pump (e.g., a syringe pump) in accordance with one or more embodiments.

FIG. 9D illustrates an example embodiment in which the automation system uses computer vision to identify and understand the functions of buttons on a machine (e.g., a centrifuge) in accordance with one or more embodiments.

FIG. 10 illustrates an example GUI for displaying a lab protocol having multiple atomic actions in accordance with one or more embodiments.

FIG. 11 illustrates an example GUI of a mobile application that allows users to monitor and control an automation system during an execution of a lab protocol in accordance with one or more embodiments.

FIG. 12 is a flowchart of an example method for generating a machine executable lab protocol based on demonstration in accordance with one or more embodiments.

FIG. 13 is a flowchart of an example method for generating a machine-executable lab protocol based on a human-written lab protocol in accordance with one or more embodiments.

FIG. 14 is a block diagram of an example computer suitable for use in the networked computing environment of FIG. 1 in accordance with one or more embodiments.

The figures depict embodiments of the present disclosure for illustration purposes only. One skilled in the art will readily recognize from the following description that alternative embodiments of the structures and methods illustrated herein may be employed without departing from the principles or benefits touted by the disclosure described herein.

### DETAILED DESCRIPTION

Automatic machine tending refers to the use of automated systems, such as robots or specialized equipment, to operate machines without the need for continuous human intervention. The benefits of automatic machine tending include increased production efficiency, improved safety by reducing human interaction with potentially dangerous chemicals and/or machinery, consistent and continuous operation (including during off-hours), and the ability to reallocate human resources to tasks that require more complex decision-making or oversight.

Computer numerical control (CNC) is an automatic machine tending tool that can be used to load raw materials into a machine, start the machine's operation, and then unload the finished product once the machine cycle is complete. A CNC machine operates under the guidance of pre-set computer programs, which direct the machine's tools and machinery to perform specific actions, such as cutting, drilling, or shaping materials. For example, some CNC machines enable the creation of three-dimensional objects based on a set of codes. One way to automate tasks of a CNC machine is to obtain an application programming interface (API) for a CNC machine and write code executable by the CNC machine, causing the CNC machine to perform a set of tasks, such as loading materials, starting the machine, monitoring its operation, and unloading finished products, etc. However, this approach comes with its challenges. Firstly, acquiring and understanding the specific API for each CNC machine can be a significant barrier. APIs can vary widely in their complexity, documentation, and the programming languages they support. Engineers must invest time and effort to learn how to effectively utilize these APIs, a process that can be both time-consuming and technically demanding.

The principles described herein solve the above-described problem by introducing an automation system that incorporates a robotic arm. The robotic arm is configured to operate one or more machines physically, e.g., by loading material into the machine, activating controls of the machine, such as (but not limited to) a touch screen or other interface element of the machine, and removing the finished product from the machine. For instance, within the field of biology, the controller can be programmed to cause the robotic arm to operate a centrifuge. The automation system may use computer vision to identify buttons of a machine and/or interpret information displayed on the machine's screen

In some embodiments, multiple atomic actions are programmed and stored in a library to which the automation system has access. Each atomic action is an undividable functional action that can be combined with other atomic actions to perform more complicated functionality. The atomic actions may include pressing a particular type of button, grabbing a particular type of object, moving a grabbed object from a first location to a second location, placing a particular type of object in a particular type of container, performing image recognition, generating a report, etc.

In some embodiments, the library is stored in a cloud service, and multiple automation systems have access to the same library. Once one automation system learns to perform a new atomic action or a new lab protocol having a sequence of atomic actions, the new atomic action or lab protocol is stored in the library, and it can be performed by another automation system.

A user can generate a machine-executable lab protocol by linking one or more atomic actions in a particular order. In some embodiments, the automation system provides a graphical user interface (GUI) that visualizes atomic actions and/or a lab protocol, including interconnected multiple atomic actions. In some embodiments, the GUI allows a user to add, or drag and drop an atomic action from a catalog of atomic actions on a canvas area, and link the atomic actions via lines or arrows. In response to user input (e.g., inputting specifying an addition or linking of one or more atomic actions), the automation system updates source code of the lab protocol and compiles the updated source code automatically to generate an updated machine-executable lab protocol. In some embodiments, the user interface allows a user to use a text box to input a natural language description of the atomic action. The computer system can use natural language processing (NLP) to determine the atomic action that the user specified. The user can generate the lab protocol via natural language. As such, a user does not need to know how to program or write source code, and the user can easily generate a lab protocol via the GUI.

In some embodiments, the automation system is configured to learn from demonstrations. In some embodiments, the demonstration includes physically moving the robotic arm of the automation system by a user to operate a machine, e.g., a centrifuge, an ultra-low-temperature (ULT) freezer, an incubator, an automated tissue processor, a spectrophotometer, among others. In some embodiments, the demonstration includes a user performing a lab protocol, and an image sensor of the automation system tracing a user's hand to learn what the user's hand has done. The automation system uses computer vision to semantically understand the operation, such as which buttons were pressed, which lid was opened, etc. The automation system, in turn, learns from that demonstration. As such, even if the machine is moved into another environment, the automation system is still capable of using it to perform the lab protocol.

In some embodiments, an automation system is configured to process a human-written protocol, such as using a centrifuge, and generate software code for the automation system to execute. In particular, the automation system or the computer system uses natural language processing (NLP) to process the human-written protocol to identify a sequence of lab actions, and generate software code for the automation system; when executed, the software code causes the robotic arm 210 to perform the sequence of lab actions.

In some cases, human-written protocols do not specify the type of object—be it a vial, tube, or plate—to be placed in a centrifuge, nor do they mention a specific centrifuge model. However, this information is necessary for an automation system to execute the laboratory action accurately. To address this, in some embodiments, the automation system prompts the user to provide the missing details, such as the sample type for centrifugation and the centrifuge model to be used. Alternatively, in other embodiments, the automation system employs computer vision to identify the object and the available machine type, subsequently assuming that the identified object should be placed in the recognized machine type.

In some embodiments, when the automation system encounters an unfamiliar type of machine (e.g., a specific model of a centrifuge) for the first time, it is configured to learn the machine's protocol either through a demonstration or by referencing the protocol of a similar, previously encountered machine. For instance, machines like centrifuges typically feature an ‘on’ button, as well as speed and time readouts. Demonstrations can guide the automation system in locating the ‘on’ button, speed readout, and time readout. In some embodiments, the automation system can map these elements to an existing protocol. Additionally, demonstrations may involve physically moving the automation system's arm to press the ‘on’ button and directing its image sensor to capture the speed and time readouts. Alternatively, in some embodiments, a computer vision algorithm is utilized to train the system on different machines, enabling it to identify the ‘on’ button on new, previously unseen machines.

In some embodiments, the automation system is designed to identify outliers. In some embodiments, it generates a distribution of correct behaviors and flags any actions that fall outside this distribution as outliers. For instance, if the automation system attempts to retrieve a tube from a designated location and finds no tube present, this deviation from the expected behavior could indicate that the tube has been displaced or was never loaded by the user. Upon detecting such an outlier, the automation system may be programmed to alert the user, ensuring prompt attention to the discrepancy.

In some embodiments, the automation system provides a graphical user interface (GUI) that may be displayed on a user client device (such as a personal computer, a laptop, a tablet, and/or a mobile phone, among others), allowing users to monitor and/or control the robotic arm remotely. The GUI can display near real-time images or videos captured by the automation system's imaging sensor. Additionally, the system may be equipped with an array of imaging sensors positioned at various locations, each designed to capture different views of the machine and the robotic arm from multiple perspectives. In some cases, an imaging sensor is mounted on the end effector of the robotic arm, enabling detailed visualization of the end effector's operations.

### Example Operating Environment for the Automation System

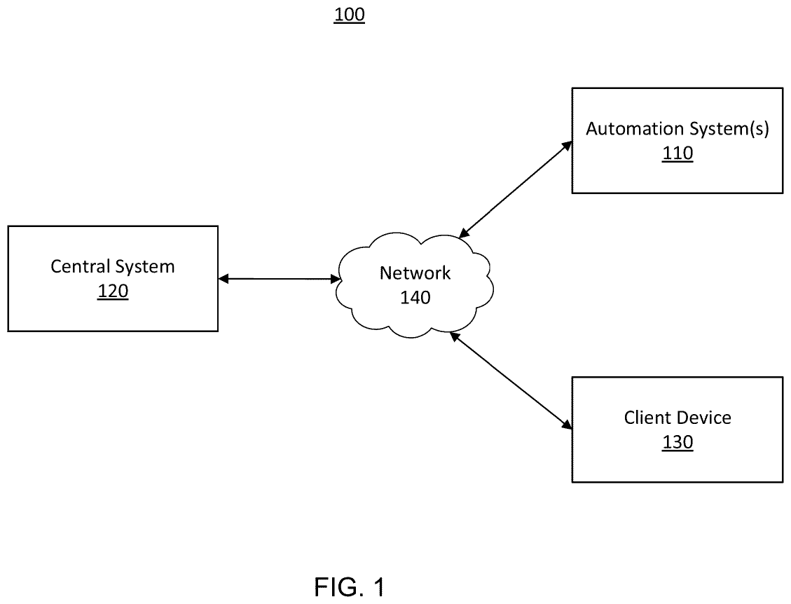

FIG. 1 illustrates an example environment 100, in which an automation system 110 may be implemented in accordance with one or more embodiments. Environment 100 includes automation system 110, central system 120, and client device 130 configured to communicate with each other via network 140. Alternative embodiments may include more, fewer, or different components from those illustrated in FIG. 1, and the functionality of each component may be divided between the components differently from the description below.

The network 140 may include one or more local area networks (LANs) or one or more wide area networks (WANs). The network 140, as referred to herein, is an inclusive term that may refer to any or all of standard layers used to describe a physical or virtual network, such as the physical layer, the data link layer, the network layer, the transport layer, the session layer, the presentation layer, and the application layer. The network 140 may include physical media for communicating data from one computing device to another computing device, such as multiprotocol label switching (MPLS) lines, fiber optic cables, cellular connections (e.g., 3G, 4G, or 5G spectra), or satellites. The network 140 also may use networking protocols, such as TCP/IP, HTTP, SSH, SMS, or FTP, to transmit data between computing devices. In some embodiments, the network 140 may include Bluetooth or near-field communication (NFC) technologies or protocols for local communications between computing devices. The network 140 may transmit encrypted or unencrypted data.

The automation system 110 includes a robotic arm 210 configured to operate one or more machines physically. In some embodiments, the automation system 110 also includes one or more cameras configured to capture images of a machine or an environment in which the machine resides. Computer vision may be utilized to identify the machine's buttons and/or interpret information displayed on the machine's screen, guiding the robotic arm 210's end effector 220 to press specific buttons in a manner similar to human interactions. In some embodiments, the robotic arm 210 is coupled to multiple end effectors 220 and is configured to select one based on the lab protocol it is executing. Each lab protocol comprises a series of atomic actions, each corresponding to a set of executable code. When executed, this code causes the robotic arm 210 to perform the corresponding atomic action. This executable code can be programmed manually or generated by the automation system 110 based on learning from demonstrations or natural language inputs from the user.

In some embodiments, the automation system 110 can learn from demonstrations. Such a demonstration includes a user manually maneuvering the robotic arm 210, selecting an end effector 220, and guiding the end effector 220 through a lab protocol. During this process, the system captures both the selection and movement related to the protocol. By recording the sequence of actions during the demonstration, the automation system 110 can replicate the lab protocol by sequentially executing the recorded actions.

In some embodiments, the central system 120 manages and stores repositories of atomic actions and/or lab protocols. The automation system 110 can access these repositories via network 140. In some embodiments, upon learning a new atomic action or lab protocol, the automation system 110 transmits information related to the new atomic action or lab protocol to the central system 120 for storage. This process ensures that when a new automation system 110 is deployed, it can directly retrieve the atomic actions and lab protocols from the central system 120's repositories, bypassing the need for relearning. Furthermore, in some embodiments, multiple automation systems 110, each learned different atomic actions and lab protocols, can share their knowledge with the central system 120. Consequently, the central system 120 builds crowd-sourced repositories of atomic actions and lab protocols, enabling any automation system 110 to benefit from the collective learning, thereby avoiding repetitive learning or programming.

The client device 130 can be a personal computer, laptop, tablet, or mobile device of a user. The client device 130 is configured to communicate with either the automation system 110 and/or the central system 120. In some embodiments, the client device 130 is installed with an application, such as a mobile application. This application provides functionalities for users to initiate or stop lab protocols, in addition to monitoring the status of machines and the progress of active lab protocols.

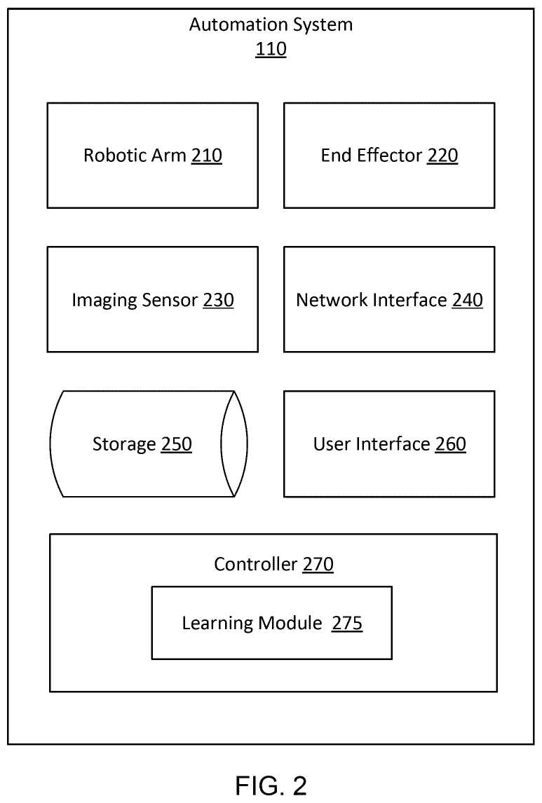

Additional details about the automation system 110, the central system 120, and the client device 130 are further described below with respect to FIGS. 2 through 13.

FIG. 2 illustrates an example architecture of an automation system 110 in accordance with one or more embodiments. The automation system 110 includes one or more robotic arm(s) 210, one or more end effector(s) 220, one or more imaging sensor(s) 230, one or more network interface(s) 240, one or more storage device(s) 250, one or more user interface(s) 260, and a controller 270. Some embodiments of the automation system 110 have different components than those described here. Similarly, in some cases, functions can be distributed among the components in a different manner than is described herein.

A robotic arm 210 is a programmable mechanical arm with similar functions to a human arm. The robotic arm 210 may include links connected by joints, allowing for rotational movement (such as pitch and yaw) or linear displacement. Each link acts as a supportive structure that holds the joints and other components, such as (but not limited to) motors, sensors, and actuators in place. A length and material of the links determine the arm's strength and durability. They may be made from metals or composites that can withstand stresses of lab protocols the arm performs. Joints are the connecting elements that provide the robotic arm 210 its flexibility and movement. Joints include (but are not limited to) rotational joints (also referred to as “revolute joints”) and linear joints (also referred to as “prismatic joints”).

Rotational joints allow for circular movement around a particular axis. These joints enable the arm to perform lab protocols that require turning, twisting, or spinning actions. The range of motion is often defined in terms of degrees or radians, indicating how far the joint can rotate from its initial position. The linear joints enable movement along a straight line. This type of joint allows the robotic arm 210 to extend or retract. Linear joints enable the robotic arm 210 to perform lab protocols that require the arm to reach out or pull back, adjusting its length to position objects precisely or to access tight space. By combining links and joints, the robotic arm 210 can perform a wide range of lab protocols with precision and flexibility. Rotational joints allow the arm to orient objects or tools, while linear joints adjust the reach of the arm. This combination enables the robotic arm 210 to mimic many of the movements of a human arm, from simple lab protocols like picking up and placing objects to more complex operations like operating machinery. The dimension and configuration of links and joints may be tailored based on demands of the lab protocols that are intended to be performed.

The robotic arm 210 is coupled to one or more end effectors 220 configured to manipulate objects by moving, picking, placing, or using tools through a combination of movements. The end effectors 220 may include (but is not limited to) a gripper configured to grip an object of a particular shape, a stylus configured to perform operations on a touch screen, a pointer configured to press a button, a pipette (such as a serological pipette, an integrated high-volume pipetting) configured to measure a quantity of liquid, a vacuum gripper configured to pick up workpieces, a microscopic camera configured to capture an image of a subject, a tube screw cap opener configured to open tube screw cap, etc. In some embodiments, an end effector 220 is integrated with a syringe pump to enable high-volume pipetting, a functionality not available in conventional robotic end effectors 220. This integration allows for precise liquid handling capabilities that exceed the typical microliter range, venturing into milliliter volumes with serological pipettes. In some embodiments, an end effector 220 is configured to interact with laboratory equipment and processes, such as kinematic coupling for precise control over lab instruments, enabling a broader application beyond mere object manipulation. This includes capabilities to retrofit existing systems with new functionalities to enhance robotic interaction with lab instruments.

In some embodiments, the robotic arm 210 is coupled to a combination of multiple end effectors 220 and configured to select one of these end effectors 220 based on a lab protocol that is to be performed. In some embodiments, an end effector 220 is configured to perform a variety of lab protocols, such as opening and closing containers, using pipettes (including high-volume pipetting with serological pipettes), and employing a vacuum for manipulation. This flexibility enables the automation system 110 to adapt to different lab protocols through simple modifications, such as adding sleeves or attachments to handle various lab tools and containers.

The storage device 250 is configured to store various types of data temporarily or permanently. Such data may include (but are not limited to) a library of atomic actions, a library of machine-executable protocols, pre-trained computer vision models, pre-trained natural language processing (NLP) models, firmware, or other software that are executable by the automation system 110. The storage device 250 is also configured to collect and store status or other metadata about lab protocols performed by the automation system 110 or metadata about the automation system 110. Such data may include lab protocol identification (e.g., unique identifiers for each lab protocol, including a lab protocol number or name, which helps in tracking and referencing specific lab protocols), timestamps (e.g., start and end times for each lab protocol, or each atomic action in each lab protocol, offering insights into the duration and scheduling of lab protocols), position and orientation data (e.g., coordinates and orientation angles of the robotic arm 210 or the end effector 220 at the start, during, and end of the lab protocol), motion parameters (e.g., information on the speed, acceleration, and path taken b the robotic arm 210 during the lab protocol), sensor readings (data from sensors equipped on the robotic arm 210, such as fore sensors, torque sensors, and proximity sensors, providing feedback on the interaction between the arm and its environment), outcome status (e.g., success or failure status of each lab protocol or atomic action within the ask, including error codes or descriptions of issues encountered), environmental conditions (e.g., information on the environment in which the lab protocol is performed, such s temperature, humidity, or presence of obstacles), user inputs (e.g., commands or parameters set by a user for the lab protocol, including any adjustments or overrides made), energy consumption (e.g., data on the power usage of the robotic arm 210 during the lab protocol), maintenance and calibration records (e.g., information on maintenance activities and calibration adjustments made to the robotic arm 210 before and after the lab protocol). The collected data can be transmitted to a client device 130 via the communication interface for further analysis or to optimize future performance of lab protocols, enhancing precision, improving safety, and/or maintaining the automation system effectively.

The controller 270 may include one or more processors coupled to memory, such as random access memory (RAM). One or more processors are configured to load one or more software modules onto the RAMs, and execute the software modules to control the automation system and cause the automation system to perform various actions. In some embodiments, the automation system 110 has firmware or an operating system installed thereon. The operating system may include (but is not limited to) a real-time operating system (RTOS), Linux (e.g., versions tailored for real-time applications, Robot Operating system (ROS), while not an OS in the traditional sense, capable of running on Linux distributions and providing a framework for robot software development), Windows (e.g., Windows IoT, a version of Windows tailored to the Internet of Things, Windows Embedded Compact, a version of Windows tailored in small-footprint devices requiring a graphical user interface and real-time capabilities). The operating system may be open source or proprietary. In addition to the firmware or operating system, the software modules also include modules corresponding to various atomic actions and/or lab protocols. When executed, these software modules cause the automation system 110 to perform the corresponding atomic actions and/or lab protocols. The software modules also include a learning module 275 configured to process learning data received during a learning process of a lab protocol.

In some embodiments, the learning module 275 is configured to generate source code or executable code for a learned lab protocol based on the learning data. In some embodiments, the learning module 275 identifies a sequence of atomic actions based on the learning data, retrieves code corresponding to each of the identified atomic actions from a repository, and combines the retrieved code to generate code for the lab protocol.

In some embodiments, the learning module 275 is configured to use an NLP model to generate source code for the lab protocol. The NLP model may be a pre-trained large language model (LLM), and the learning module 275 is configured to generate a prompt in natural language using the received learning data about the lab protocol and forward the prompt to the LLM, causing the LLM to generate the source code for performing the lab protocol. In some embodiments, the NLP model is deployed onto the automation system 110. Alternatively, the NLP model is a service hosted on a cloud platform, where the automation system 110 uses an application programming interface (API) to transmit prompts to the NLP model and receive results back from the NLP model.

The network interface 240 may include a Wi-Fi interface, an NFC interface, a LAN interface, a telecommunication interface, such as 2G, 3G, 5G, 6G or any future communication interfaces. The network interface 240 enables the automation system 110 to communicate with the central system 120 and/or the client device 130. For example, the automation system 110 may be able to upload newly learned atomic actions and/or lab protocols to the central system 120, or download existing atomic actions and/or lab protocols from the central system 120. The automation system 110 may also be able to transmit its current status to the client device 130, and receives instructions from the client device 130, such as start or stop a lab protocol.

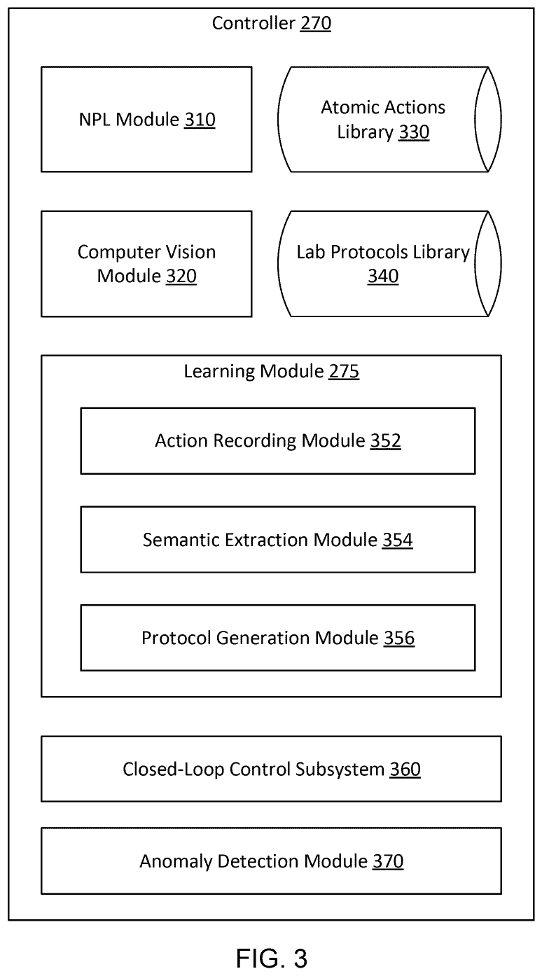

FIG. 3 illustrates an example architecture of controller 270 in accordance with one or more embodiments. The functions of the controller 270 may be achieved by a combination of hardware (e.g., processors, memory) and software (e.g., firmware, operating system, specialized software). Controller 270 includes an NLP module 310, a computer vision module 320, an atomic action library 330, and a lab protocols library 340. Some embodiments of the automation system 110 have different components than those described herein. Similarly, in some cases, functions can be distributed among the components in a different manner than is described herein.

The NLP module 310 includes machine-learning models trained to receive natural language text inputs and generate responses based on these inputs. These inputs can originate from a user or be produced by another component within the automation system 110. In some embodiments, the NLP module 310 is configured to receive a voice command uttered by a user, determine a lab protocol corresponding to the voice command, and cause the robot arm to perform the lab protocol.

In some embodiments, the NLP module 310 is configured to receive a text prompt from a user describing a lab protocol, including a series of actions. Alternatively, or in addition, the learning module 275 is configured to generate a text prompt based on data describing a series of actions performed during a learning process. Upon receiving the text prompt, the NLP module 310 is configured to generate source code based on the text prompt. The source code is compiled into executable code. When executed, the executable code causes the robotic arm 210 to perform the lab procedure or lab protocol described in the text prompt.

In some embodiments, the NLP module 310 uses machine-learning models deployed on the automation system 110. Alternatively, the NLP module 310 uses machine-learning models hosted on a cloud platform and accessible by the automation system 110 via network 140. In some embodiments, the NLP module 310 uses a pre-trained LLM. Alternatively, or in addition, the LLM is fine-tuned further based on source code specific to the automation system 110. In some embodiments, the LLM is configured to perform contextual learning. This enables the LLM to take into account context provided in the prompt when generating a result.

The computer vision module 320 is configured to use machine-learning models to detect and recognize objects from images acquired by the imaging sensor 230. This capability enables the automation system 110 to identify and locate specific objects of interest, such as (but not limited to) a machine, a component of the machine, obstacles, boundaries of a platform, or people. The computer vision module 320 can help the robotic arm 210 navigate through environments and plan paths to reach their destinations. The computer vision module 320 can also help the robotic arm 210 interact with objects and manipulate them with precision, such as (but not limited to) guiding the robotic arm 210 to grasp, pick, and place objects based on visual cues.

In some embodiments, the computer vision module 320 can also help the learning module 275 interpret demonstrative lap protocols conducted during learning processes. For example, when an end effector 220 of the robotic arm 210 is used to press a machine button, the computer vision module 320 identifies the button's shape and location relative to the machine. Additionally, the computer vision module 320 can also recognize any symbols or text on or adjacent to the button. In some embodiments, the computer vision module 320 is configured to identify the button's function based on the symbol or text linked to the button.

As another example, during a learning process, an end effector 220 of the robotic arm 210 is used to grasp an object, such as a tube. The computer vision module 320 is configured to recognize both the object's shape being grasped and the shape of the end effector 220 itself and determine the specific type of object in the grasp of a specific type of end effector 220 based on their shapes, thereby classifying the action as the use of a particular end effector type to handle a specific kind of object.

Controller 270 also includes a learning module 275 configured to learn from demonstration and/or human-written protocols (written in a natural language, such as English). In some embodiments, the learning module 275 includes an action recording module 352, a semantic extraction module 354, and a protocol generation module 356. The action recording module 352 is configured to record a sequence performed by a demonstration. The semantic extraction module 354 is configured to extract semantic meanings of each action in the sequence. In some embodiments, the semantic extraction module 354 uses computer vision module 320 to identify a semantic meaning of a particular action, e.g., a semantic meaning of a button that is pressed in an action, or a shape of an object that is grabbed in an action, which may be a tube or a vile, etc.

In some embodiments, the learning module 275 causes the computer vision module 320 to track pellets in a tube, track cell counts, and track how much liquid is in the pipette tip, among others. In some embodiments, the learning module 275 causes the computer vision module 320 to read a screen of the machine to identify feedback generated by the machine or machine state to further higher-level functionality. In some embodiments, the learning module 275 causes the computer vision module 320 to scan a tag or a bar code attached to the machine to identify the machine or components of the machine.

The protocol generation module 356 is configured to generate a machine-executable protocol based on the semantic meaning of the sequence of actions. In some embodiments, the atomic actions library 330 stores source code for each atomic action, and the protocol generation module 356 identifies a series of atomic actions in the atomic actions library 330, retrieves source code corresponding to each atomic action in the series from the library 330, links the retrieved source code to generate unified source code for the lab protocol, and then compiles the source code to produce a machine-executable code for the lab protocol. Alternatively, the atomic action library 330 stores machine-executable code for each atomic action, and the protocol generation module 356 retrieves machine-executable code for each atomic action in the series from the library 330, links the retrieved executable code to generate unified executable code for the lab protocol. The generated source code or executable code for the lab protocol is assigned an identifier and/or a name and stored on the automation system 110. In some embodiments, the generated source code or executable code for the lab protocol is archived in a lab protocol library, accessible by other automation systems, such that other automation systems can also use the code to perform the lab protocol automatically.

In some embodiments, the automation system 110 includes a closed-loop control subsystem 360 that uses computer vision module 320 and/or other sensors (e.g., force torque sensors) to automatically regulate the controller 270 to maintain a desired state or set point associated with the operation of the machine without human interaction. The closed-loop control subsystem 360 uses feedback to control the dynamic behavior of automation system 110. It continuously monitors the output of the automation system 110, compares it with a desired output (such as a setpoint), and uses a difference between these two signals (also referred to as an error signal) to adjust control inputs to minimize the error.

In some embodiments, the closed-loop control subsystem 360 causes the computer vision module 320 to determine an output signal of the automation system 110 and feed this output signal back to the controller 270. The controller 270 compares the received output signal with a desired output signal to determine a difference and adjusts the automation system 110 to minimize the difference. For example, in some embodiments, the closed-loop control subsystem 360 uses computer vision module 320 to track how much liquid is in the pipette tip; and based on the tracking, the subsystem 360 causes the controller 270 to adjust a pipette end effector 220 to cause more or less liquid to be drawn into the pipette end effector 220. As another example, in some embodiments, the closed-loop control subsystem 360 uses computer vision module 320 to track how far the robot is from a button; and based on the tracking, the subsystem 360 adjusts the robotic arm 210 to cause an end effector 220 to touch the button gently, even if there may be changes to the button location. Accordingly, the closed-loop control subsystem 360 enables the automation system 110 to consistently achieve the desired performance despite alternations in the machine, environmental changes, or variations in the behavior of the robotic arm 210.

In some embodiments, controller 270 also includes an anomaly detection module 370 configured to detect anomalies. In some embodiments, cameras integrated within the automation system 110 may capture images or videos of objects or surfaces in the environment, and the anomaly detection module 370 causes computer vision module 320 to process the captured images or videos to detect anomalies such as surface defects, irregular patterns, and/or incorrect shapes. In some embodiments, the anomaly detection module 370 may use force torque sensors on the robotic arm 210 to detect anomalies through tactile feedback. If an object does not fit correctly due to a mismatch of the object and a receptacle of a machine, unexpected resistance can be detected as an anomaly.

In some embodiments, controller 270 may aggregate data from both the computer vision module 320 or force/torque sensors to establish a norm distribution, facilitating anomaly detection based on deviations from this distribution. In some embodiments, the anomaly detection module 320 may cause the computer vision module 320 to examine a machine's screen for messages or alerts that indicate an anomaly. Upon detecting an anomaly, the anomaly detection module 320 can generate and send an alert to the client device 130 to trigger the cessation or abortion of a lab protocol.

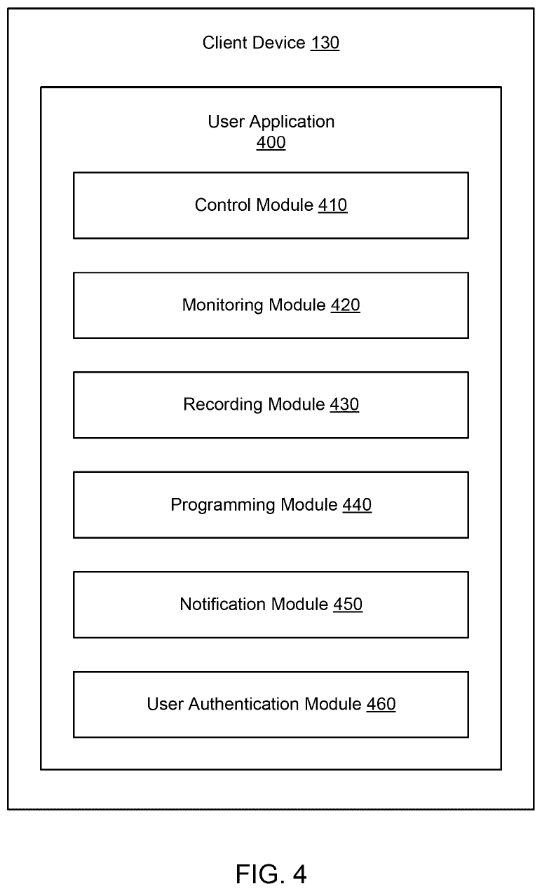

FIG. 4 illustrates an example architecture of a client device 130 in accordance with one or more embodiments. The client device 130 is a computing system that has an application 400 installed thereon configured to communicate directly or indirectly with the automation system 110 and/or the central system 120. The application 400 may be compatible with various operating systems, such as (but not limited to) iOS, Android, Windows, or Linux, among others.

The application 400 includes a control module 410 and a monitoring module 420, enabling users to manage and monitor the automation system 110 in real time. Through modules 410 and 420, users can initiate or stop a lab protocol and track the ongoing progress of a lab protocol currently in execution. In certain embodiments, the lab protocol comprises a series of atomic actions, with the application supporting the recording and playback of these actions. Additionally, the application presents real-time data from the automation system 110, such as the position, speed, and torque of the robotic arm 210, through a combination of graphical and/or numerical displays. This functionality allows users to monitor the robotic arm 210's performance and adjust its operations as needed. In some embodiments, the application 400 may include an emergency stop feature, allowing users to stop a lab protocol under any circumstances immediately. In some embodiments, the application 400 also includes a recording module 430, offering the option to record and replay the sequence of lab protocols.

In some embodiments, the application 400 also includes a programming module 440, enabling users to design and set up a sequence of lab protocols for execution by the automation system 110. In some embodiments, the programming module 440 allows users to intuitively create new lab protocols by dragging and dropping visual elements that represent atomic actions, enabling the formation of complex lab protocols without the need for programming code. For users with advanced programming skills, the programming module 440 may also provide the option to review or adjust source code of each atomic action or lab protocol, offering greater customization and control.

In some embodiments, the application 400 may also include a notification module 450 configured to alert users to any potential issues, such as malfunctions, anomalies, or safety concerns, ensuring prompt awareness and response. In some embodiments, the application 400 may also include a user authentication module 460 that requires users to verify their identity before accessing the automation system 110. This security measure ensures that access is appropriately granted based on the user's role and permissions, ranging from basic monitoring functionalities to full system control. Moreover, the application 400 might also include additional modules, such as a tutorial and support module. This module is designed to offer users comprehensive tutorials on how to operate the automation system 110 effectively, facilitating both novice and experienced users in navigating and utilizing the automation system 110 to its full potential.

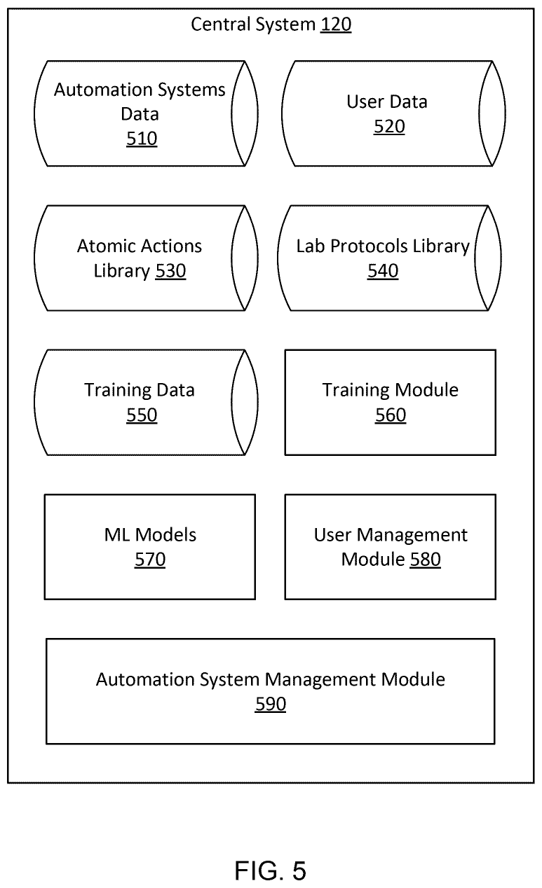

FIG. 5 illustrates an example architecture of a central system 120 in accordance with one or more embodiments. The central system 120 includes data stores that store various data, including (but not limited to) automation systems data 510 and user data 520. The automation systems data 510 includes data associated with different automation systems 110, which may be deployed at different locations and in different environments for performing different lab protocols. The user data 520 includes data associated with users who interact or use the different automation systems. The central system 120 may also include a user management module 580 and an automation system management module 590. The user management module 580 manages users of the automation systems. In some embodiments, the user management module 580 may be configured to register new users and manage existing user profiles, permissions, and other aspects related to user interactions with one or more automation systems, ensuring a secure and efficient user experience. The automation system management module 590 is configured to manage the various automation systems integrated into the central system 120. In some embodiments, the automation system management module 590 may be configured to register new automation systems and manage existing automation systems' configuration, calibration, performance, and maintenance.

The central system 120 may also include atomic actions library 530, which stores source code or executable code for various atomic actions, and/or lab protocols library 540, which stores source code or executable code for various lab protocols. As described above, the source code for atomic actions and/or lab protocols can be manually or semi-manually created and/or crowd-sourced from different automation systems 110. Once source code for an atomic action or a lab protocol has been developed and stored within the libraries 530, 540, it becomes accessible to other automation systems. This accessibility allows many automation systems to use the stored source code or executable code to perform corresponding atomic actions or lab protocols automatically with minimum user intervention.

The central system 120 may also include training data 550, alongside a training module 560 configured to utilize this data 550 for training various machine learning models 570. These models may include, but are not limited to, one or more NLP, computer vision, and anomaly detection models. As previously mentioned, an NLP model could be trained to process text input to determine a lab protocol based on said input. The training data for an NLP model might comprise pairs of text and lab protocols. Alternatively, an NLP model could be trained to interpret a prompt associated with a lab protocol and generate source code, thereby enabling an automation system to execute the lab protocol based on the prompt. In this case, the training data might include lab protocols paired with corresponding source code. Computer vision models could be trained to recognize various objects, including types of machines and their components such as buttons and displays, with their training data including images labeled with the objects they depict. Anomaly detection models, on the other hand, are trained to identify deviations within the automation systems, using data collected during both normal and abnormal operational phases as their training data.

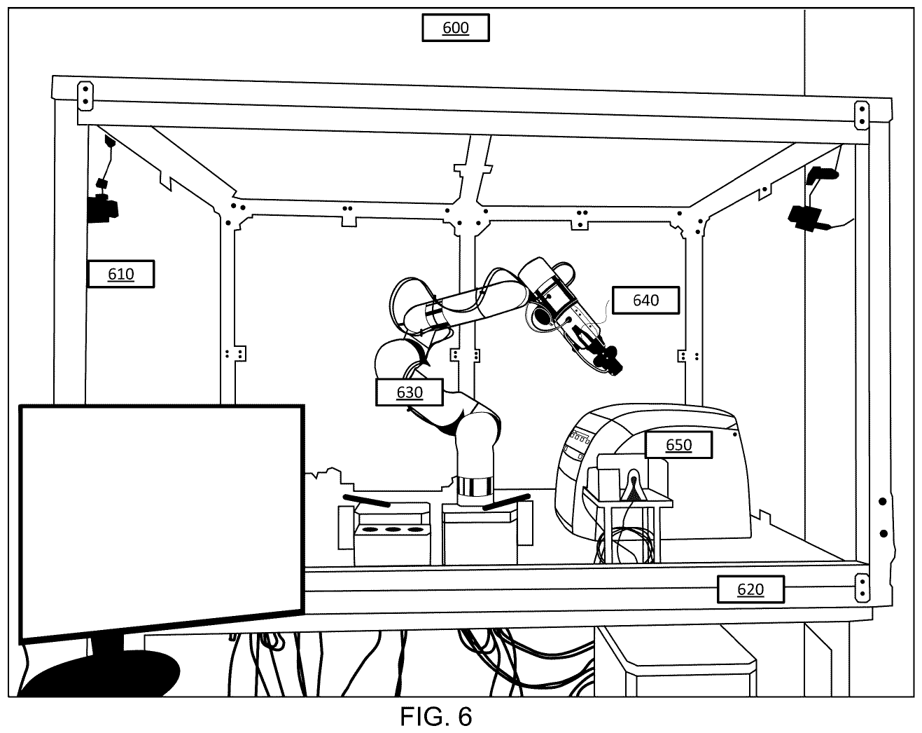

FIG. 6 illustrates a perspective view of an example automation system 600, in accordance with one or more embodiments. The automation system 600 corresponds to the automation system 110 of FIG. 1. As illustrated, the automation system 600 includes a casing 610, a platform 620, and a robotic arm 630 placed on the platform 620 inside the casing 610. The robotic arm 630 is coupled to an end effector 640. An object 640 (e.g., a tube, a vial, or a plate) and a machine 650 are placed within a range reachable by the robotic arm 630. The machine 650 may be a centrifuge configured to process a number of samples. The object 640 may be one or more tube samples. The automation system 600 is configured to cause the robotic arm 630 to perform a lab protocol including a sequence of actions. For example, a sequence of actions for lab protocol of using a centrifuge to process a tube sample might include (1) pressing a lid opening button or level to open a lid of the centrifuge 650, (2) grasping the tube sample 640 and placing the tube 640 into a rotor of the centrifuge 650, (3) gently closing the lid until it locks, (4) setting various parameters based on the lab protocol, such as a temperature, a speed, and/or time, which may be performed using control buttons or a touch screen interface of the centrifuge, and (5) pressing a start button to begin the centrifuge process.

In some embodiments, the automation system 600 also utilizes various sensors to monitor the centrifuge 650 for any signs of imbalance or unusual noise, which could indicate a problem. Once the set time has elapsed, the centrifuge 650 will decelerate and come to a stop, and the centrifuge 650 may generate an alert, such as a beep or other signal, indicating that the run has been completed. The automation system 600 may detect such a signal and cause the robotic arm 210 to perform another sequence of actions, such as (1) pressing the button to open the lid, (2) removing the tube sample 640 from the rotor, and placing the tube sample 640 onto a rack, (3) pressing a power button to turn off the centrifuge, and/or (4) grasping a cleaning wipe or tissue and wiping clean the rotor or interior if any spills occurred during operation.

Notably, the sequence of actions may be atomic actions that are reusable across other lab protocols. For example, atomic actions may include (but are not limited to) opening a machine's lid, grasping a tube sample, grasping a cleaning wipe or tissue, wiping clean the machine's surface, among others. These atomic actions can be arranged in diverse sequences to establish a variety of lab protocols.

### Example End Effectors That Can be Coupled to the Automation System

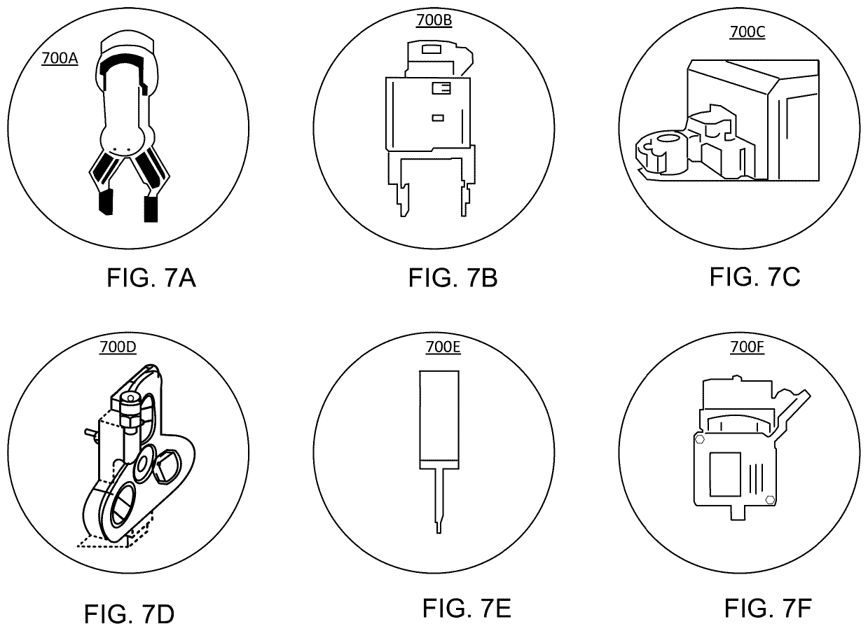

FIGS. 7A-7F illustrate various examples of end effectors 220 that may be removably coupled to the robotic arm 630 of FIG. 6 in accordance with one or more embodiments. FIGS. 7A-7C are examples of gripper end effectors that may be coupled to robotic arm 630. FIG. 7A illustrates a robotic gripper end effector 700A, which includes multiple fingers in accordance with one or more embodiments. The robotic gripper end effector 700A is configured to mimic actions of a human hand and can be used to pick up, hold, and manipulate various objects in various lab protocols.

FIG. 7B illustrates a pneumatic gripper end effector 700B in accordance with one or more embodiments. The pneumatic gripper end effector 700B is configured to pick up objects with a parallel or angular motion using compressed air. The parallel jaws are ideal for objects with flat, parallel surfaces, allowing the gripper jaws to make full contact and secure grip.

FIG. 7C illustrates a cap opener end effector 700C in accordance with one or more embodiments. The cap opener end effector 700C is configured to fit a cap into a slot or grip area and secure the cap in place. Once the cap is secure, a force is applied to the gripping mechanism, which turns the cap to open it.

FIGS. 7D-7F are examples of other end effectors 220 that may be attached to the robotic arm 630. FIG. 7D illustrates a multichannel pipette end effector 700D configured to transfer precise volumes of samples in accordance with one or more embodiments. In some embodiments, the end effector 700D is configured to use vacuum suction to hold test tubes.

FIG. 7E illustrates a pipette end effector 700E configured to measure and transfer a precise volume of samples in accordance with one or more embodiments. FIG. 7F illustrates a sensor end effector 700F in accordance with one or more embodiments. The sensor end effector 700F may be (but is not limited to) a presence sensor configured to detect whether an object, such as a test tube or vial, is in place; a barcode reader configured to scan labels on labware to identify samples; a colorimetric sensor configured to detect a color or clarify of a sample; a capacitive or inductive sensor configured to detect presence of various materials with or without direct contact; a temperature sensor configured to detect a temperature of a sample; a level sensor configured to detect a surface level of a sample; and/or an RFID reader configured to identify labware or machines tagged with RFID chips.

### Example Machines That Can be Operated by the Automation System

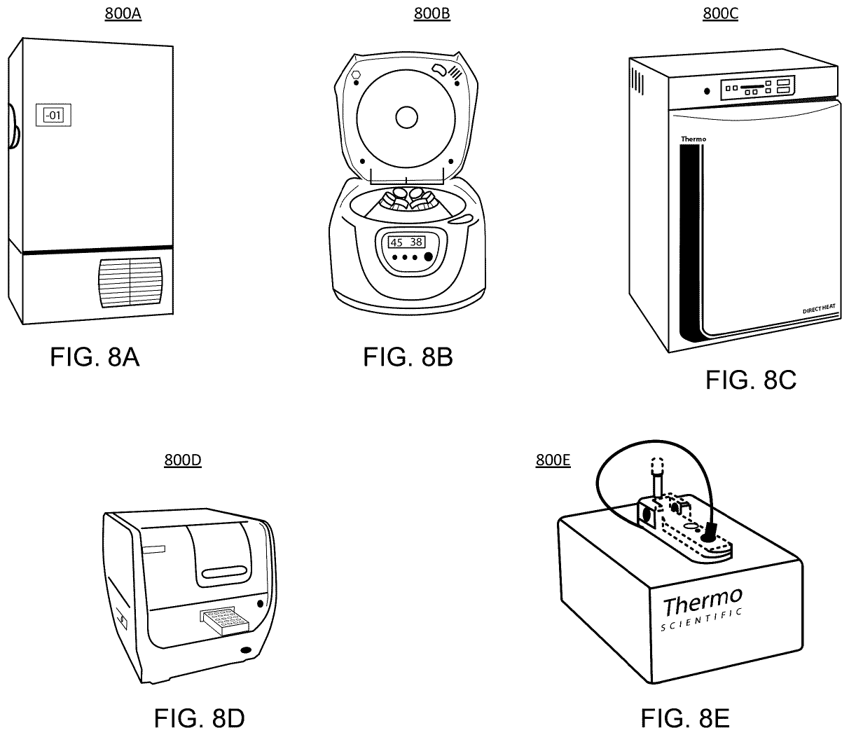

FIGS. 8A-8E illustrate various examples of machines that the automation system 110 is able to learn to operate, in accordance with one or more embodiments. FIG. 8A is an example of an ultra-low-temperature (ULT) freezer 800A configured to maintain low temperatures typically between −40° C. and −86° C. The ULT freezer 800A may be used to store drugs, enzymes, chemicals, viruses, bacteria, cell preparations, and tissue samples that require strict temperature control to remain stable and viable.

FIG. 8B is an example of a centrifuge 800B configured to separate substances of different densities within a liquid by spinning them at high speeds. Centrifuges are essential in a wide range of biological research, including DNA, RNA, and protein analysis.

FIG. 8C is an example of a biosafety cabinet 800C configured to provide a particulate-free environment and protect sensitive biological samples or cultures from contamination. The biosafety cabinet 800C may be set to have inflow and downflow air velocities. In some embodiments, the biosafety cabinet 800C may have a UV light timer among other parameters that may be set.

FIG. 8D is an example of a microplate reader 800D configured to capture visual data from microplates, which may be operated by an automation system described herein in accordance with one or more embodiments. Microplates typically have multiple wells in which cells can be cultured, or chemical reactions can take place. The microplate reader 800D includes a camera or detector that captures images of each well in a microplate. Parameters for setting the microplate reader 800D may include (but are not limited to) wavelength selection (e.g., absorbance assays, fluorescence assays), read type (single read, kinetic reads, end point reads, spectral scan, etc.), plate format, sample volume, read mode (top read, bottom read), etc.

FIG. 8E is an example of a thermocycler 800E configured to amplify segments of DNA through temperature cycling, which may be operated by an automation system described herein in accordance with one or more embodiments. The thermocycler can rapidly heat and cool reaction tubes to precise temperatures necessary for polymerase chain reaction (PCR). The parameters for setting the thermocycler 800E include (but are not limited to) a number of cycles, denaturation, denaturation temperature and time, annealing temperature and time, extension temperature and time, final extension, hold temperature, lid temperature, volume of reaction, ramp rate, etc.

The automation system 600 can learn (or be programmed) to operate each of the machines 800A through 800E. For example, the automation system 600 can direct the robotic arm 630 to manage samples within the ULT freezer 800A, including both retrieval and storage. Furthermore, the automation system 600 can operate the centrifuge 800B or biosafety cabinet 800C by directing the robotic arm 630 to open and close a lid, insert samples, configure operational settings, start operation, and remove samples upon completion. The automation system 600 can operate the microplate reader 800D by directing the robotic arm 630 to load and unload slides, run a camera, and download output data. The automation system 600 can also operate the thermocycler 800E by directing the robotic arm 630 to power on the device, and program it with a desired temperature profile (e.g., initial denaturation temperature and time, annealing temperature and time, extension temperature and time, final extension temperature and time, and hold temperature at the end), place PCR tubes or plate in the thermocycler 800E, close the lid, and monitor the run, and conclude the process by removing the PCR tubes or plate, and storing the amplified DNA at a particular temperature for downstream applications.

The machines depicted in FIGS. 8A-8E represent just a selection of the equipment that the automation system 600 is able to handle. The system's capabilities extend to additional devices, including, but not limited to, flow cytometers, cell counters, thermocyclers, and/or polymerase chain reaction (PCR). For instance, the automation system 600 can operate cell-sorting machines, encompassing tasks such as pipetting, opening and closing tubes, loading samples, and relocating tubes. Furthermore, the automation system 600 can also operate thermocyclers or polymerase chain reaction (PCR) machines, which may involve processes like placement on hot or cold plates and vertexing. Broadly speaking, the automation system 600 is capable of operating any machine that human operators can operate.

### Example User Demonstration to the Automation System

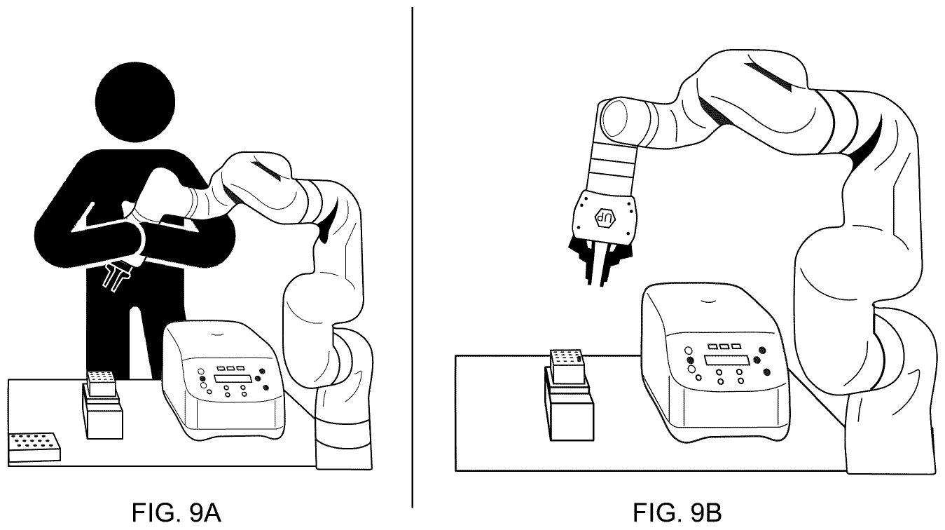

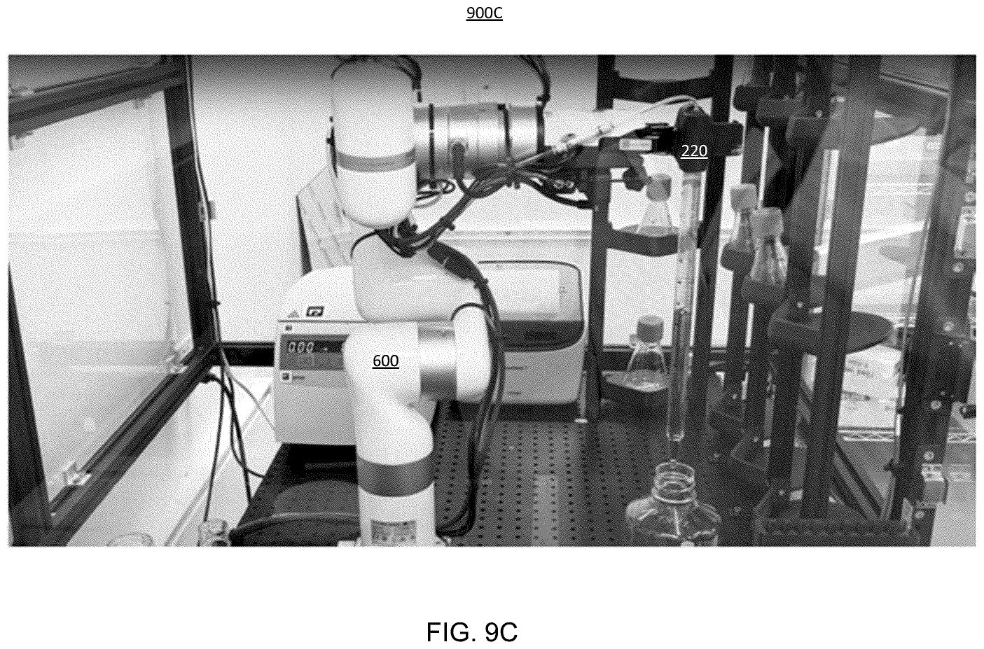

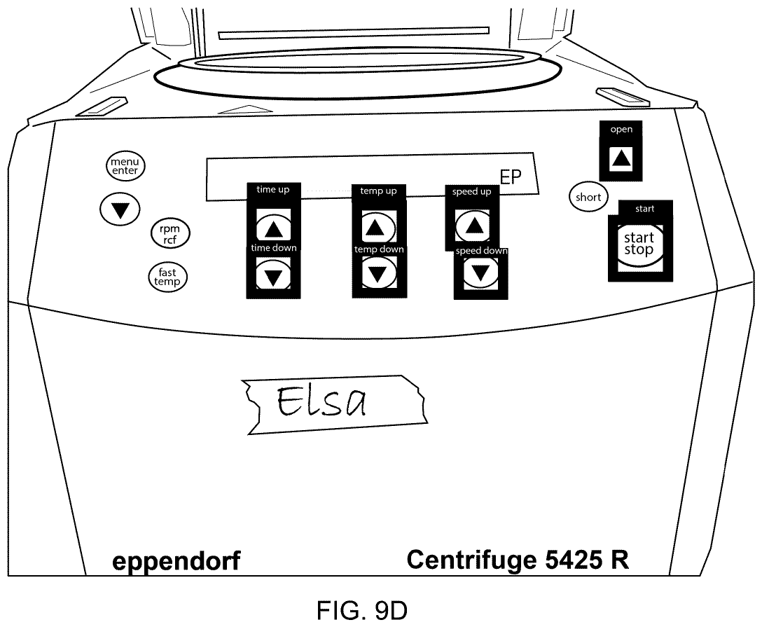

FIG. 9A illustrates an example embodiment where a user demonstrates a lab protocol for operating a centrifuge to the automation system 110, in accordance with one or more embodiments. The demonstration includes manipulating the robotic arm 210 of the automation system 110 and its end effector 220 to perform a series of actions to use the centrifuge. The demonstrated actions include using the end effector 220 to grasp a tube from a tube rack, pressing a button on the centrifuge to open a lid of the centrifuge, and placing the tube inside the centrifuge, among other steps. In some embodiments, the automation system 110 stores the learned protocol in the protocol library after the demonstration. In some embodiments, users can interact with or adjust each protocol via a graphical user interface (GUI).

FIG. 9B illustrates the aftermath of the demonstration, where the automation system 110 has learned the protocol for operating the centrifuge. Subsequently, the automation system 110 performs the learned protocol for the user's evaluation. Should there be any inaccuracies or faults in the evaluation process, the user has the option to correct the protocol through the GUI or by re-demonstrating the protocol.

FIG. 9C illustrates an example environment 900C in which the automation system 110 is coupled to a serological pipette end effector 220 and a pump (e.g., a syringe pump) in accordance with one or more embodiments. The integration of a pump with a serological pipette end effector 220 enables high-volume pipetting, a feature not available in any existing robotic systems. Such an advancement enables the automation system 600 to precisely handle liquids in volumes extending beyond the conventional microliter range, reaching milliliters. This represents a significant enhancement in liquid handling capabilities, setting a new standard for precision and efficiency in robotic systems.

FIG. 9D illustrates an example embodiment where the automation system 600 uses computer vision to identify and understand the functions of buttons on a machine (e.g., a centrifuge) in accordance with one or more embodiments. As illustrated, the automation system 600 captures an image of the machine using a camera or sensor. The computer vision module identifies buttons within the captured image, labeling each with bounding boxes and text annotations that describe their functions. For example, on the centrifuge's middle section, a left pair of up and down arrows are labeled “time up” and “time down” for adjusting time, a middle pair of up and down arrows are labeled “temp up” and “temp down” for adjusting temperature, a right pair of up and down arrows are labeled “speed up” and “speed down” for adjusting speed. Additionally, on the right section of the centrifuge, a start/stop button is labeled “start”, and a lid control button is labeled “open,” indicating their respective functionalities.

### Example Graphical User Interface (GUI) for the Automation System

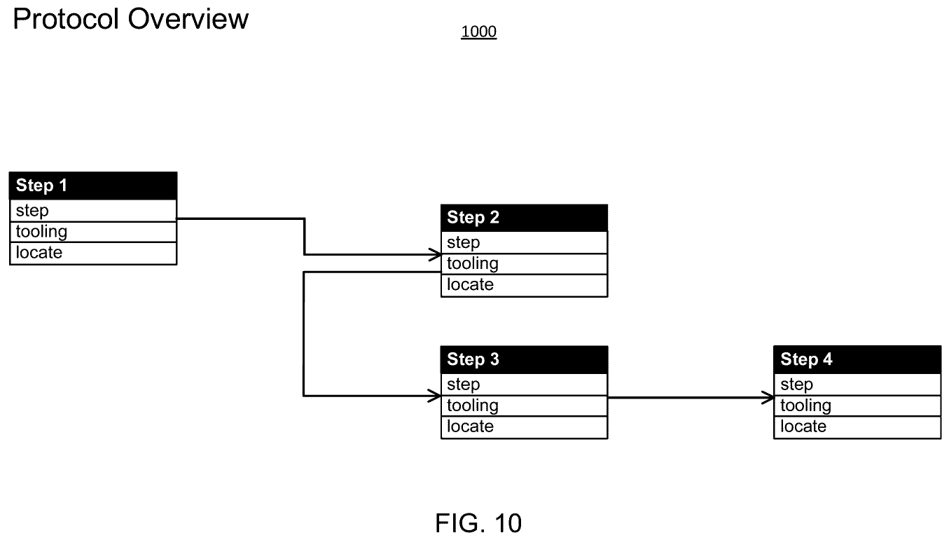

FIG. 10 illustrates an example GUI 1000 for displaying a protocol in accordance with one or more embodiments. As illustrated, the protocol includes steps 1-4, and each step is associated with one or more parameters, such as a step name, a tool that is used to perform the step, and any information associated with the step (such as a quantity of reagent, a length of time associated with the step, and the like), etc. Certain parameters might be static and unalterable, e.g., parameters related to the characteristics of a machine, while others can be adjusted by users, e.g., in a pipetting action, the volume of liquid to be drawn by the pipette is a parameter that users can modify.

Each step corresponds to an atomic action in a library of atomic actions. Source code of each atomic action has been written and stored in the library. Advanced users can write their own source code to create new atomic actions or to call existing atomic actions, although users do not need to know how to program or write source code to generate or modify a protocol. For example, a user can simply use the GUI 1000 to add, remove, and/or link atomic actions to generate a lab protocol. Responsive to the user input, the automation system 110 modifies the source code of the lab protocol and compiles the modified source code into an executable lab protocol.

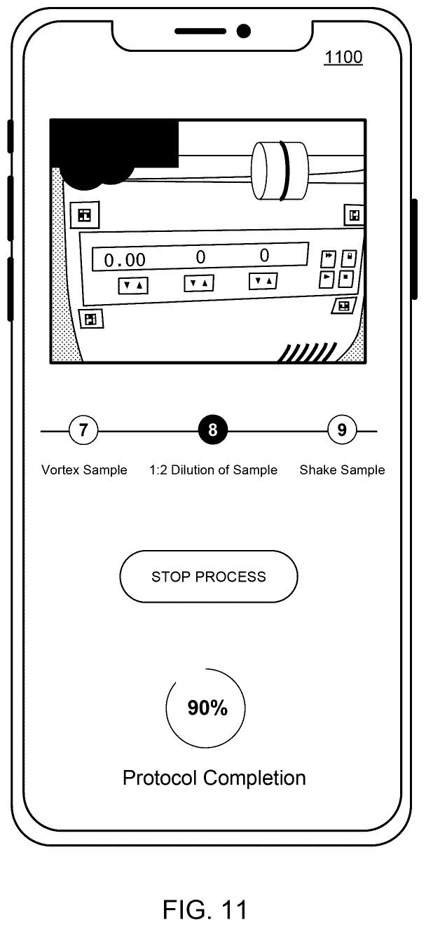

In some embodiments, users have the capability to monitor and control the automation system 110 remotely while it executes a lab protocol. FIG. 11 illustrates an example GUI 1100 of a mobile application that allows users to monitor and control the automation system 110 during an execution of a lab protocol in accordance with one or more embodiments. The GUI 1100 presents a live camera feed showing the vicinity of the robotic arm 210 or its end effector 220, providing real-time visual oversight of operations. It further displays the specific task within the lab protocol that the automation system is executing, along with the preceding and subsequent tasks, enhancing user understanding of the workflow sequence. Additionally, the GUI 1100 offers a snapshot of the overall progress of the protocol, for instance, indicating completion up to 90%. This interface may also allow users to pause or restart tasks within the lab protocol or to navigate directly to a particular task as needed.

Within the displayed protocol, a range of tasks is enumerated, including vortexing a sample as the 7th of 9 tasks in the protocol, diluting a sample as the 8th of 9 tasks in the protocol, and shaking a sample as the final 9th task in the protocol. As illustrated in the GUI 1100, the vortexing task has already been completed. The automation system 110 is currently working on diluting a sample at a 1:2 ratio. The subsequent task will involve shaking the sample.

In some embodiments, the automation system 110 allows users to generate lab protocols via natural language. For example, in some embodiments, the GUI 1000 provides a text box for user to input a natural language description of the atomic action. Alternatively, or in addition, the automation system 110 is able to listen to user's voice commands in a natural language, the voice commands may include a description of an atomic action. The system 110 can use natural language processing (NLP) to determine the atomic action that the user specified.

### Example Methods for Automated Machine Tending

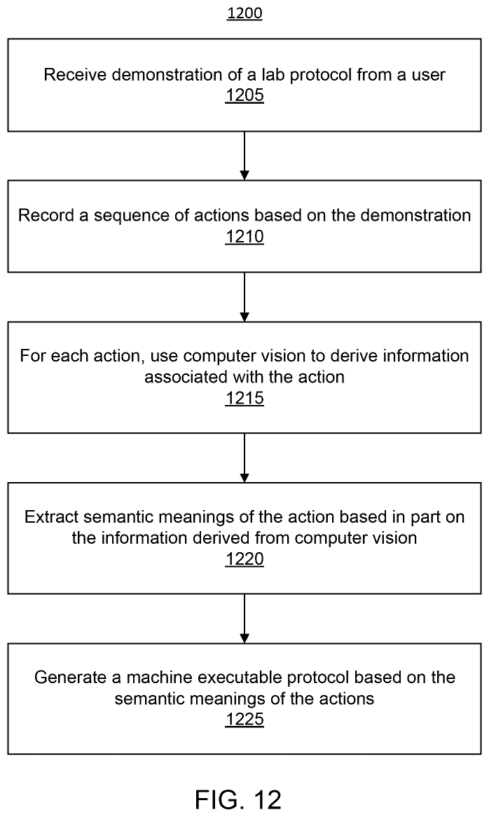

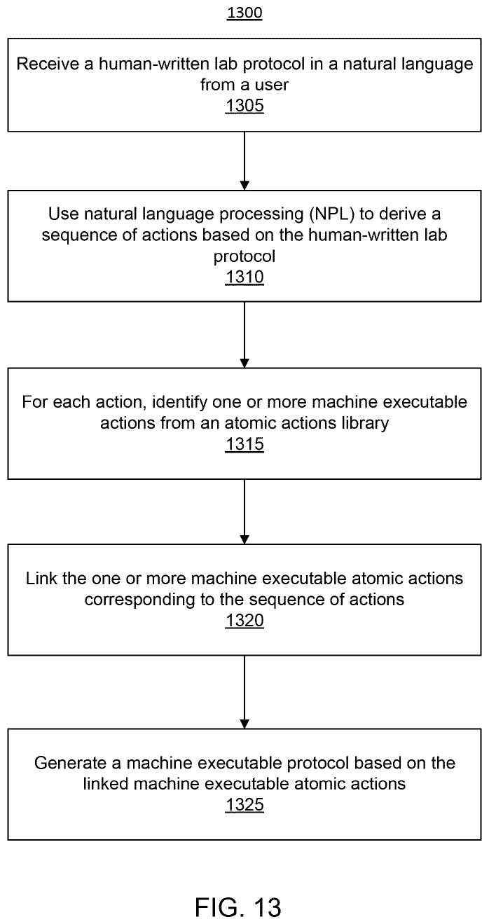

FIGS. 12-13 are flowcharts of example methods 1200 and 1300 that may be performed by the automation system 110 or any computer system that is capable of communicating with the automation system 110 or the robotic arm 210. In various embodiments, the method 1200 or 1300 includes different or additional steps than those described in conjunction with FIG. 12 or 13.

FIG. 12 is a flowchart of an example method 1200 for generating a machine executable lab protocol based on demonstration. The automation system receives 1205 a demonstration of a lab protocol from a user. In some embodiments, the demonstration may include the user physically moving a robotic arm 210 and/or an end effector 220 of the robotic arm 210 to perform a sequence of actions on a machine. Alternatively, or in addition, the demonstration may include the user physically performing the lab protocol themselves. The user may be wearing a special glove that is identifiable by the automation system during the demonstration, such that the hand motion of the user can be traced by the automation system 110.

The automation system 110 records 1210 the sequence of actions based on the demonstration. The step of recording 1210 includes recording a sequence of physical motions that are performed by the robotic arm 210 and/or the end effector 220, and/or recording a sequence of images or a video surrounding the end effector 220. The sequence of images or video may include an image of a button that was pressed by the end effector 220, or an object that was grabbed by the end effector 220.

For each action in the sequence of actions, the automation system 110 uses 1215 computer vision to derive information associated with the action, such as a button pressed by the end effector 220 and an object grabbed by the end effector 220. In some embodiments, computer vision can also be used to track pellets in a tube, cell counts, and how much liquid is in the pipette tip. In some embodiments, computer vision can also be used to read a screen of the machine to identify feedback or machine state to further higher level functionality. In some embodiments, a tag or a bar code is attached to the machine to allow easier identification of buttons or parts of the machine.

The automation system 110 extracts 1220 semantic meanings of the action based in part on the information derived from computer vision. For example, the particular button is an on button that opens a lid of a centrifuge. The automation system 110 then generates 1225 a machine-executable protocol based on the semantic meaning of the actions. In some embodiments, the automation system 110 has a library of atomic actions. For each action in the sequence, the automation system 110 identifies one or more atomic actions from the library based on the semantic meaning of the action, and links the atomic actions in a particular order to generate the protocol.

FIG. 13 is a flowchart of an example method 1300 for generating a machine-executable lab protocol based on a human-written lab protocol. The automation system 110 receives 1305 a human-written lab protocol in a natural language, such as English. The automation system 110 uses 1310 natural language processing (NLP) to derive a sequence of actions based on the human-written lab protocol. For each action, the automation system 110 extracts 1315 one or more machine-executable atomic actions from an atomic actions library. The automation system 110 links 1320 the one or more machine-executable atomic actions corresponding to the sequence of actions, and generates 1325 a machine-executable protocol based on the linked machine-executable atomic actions.

### Computing System Architecture

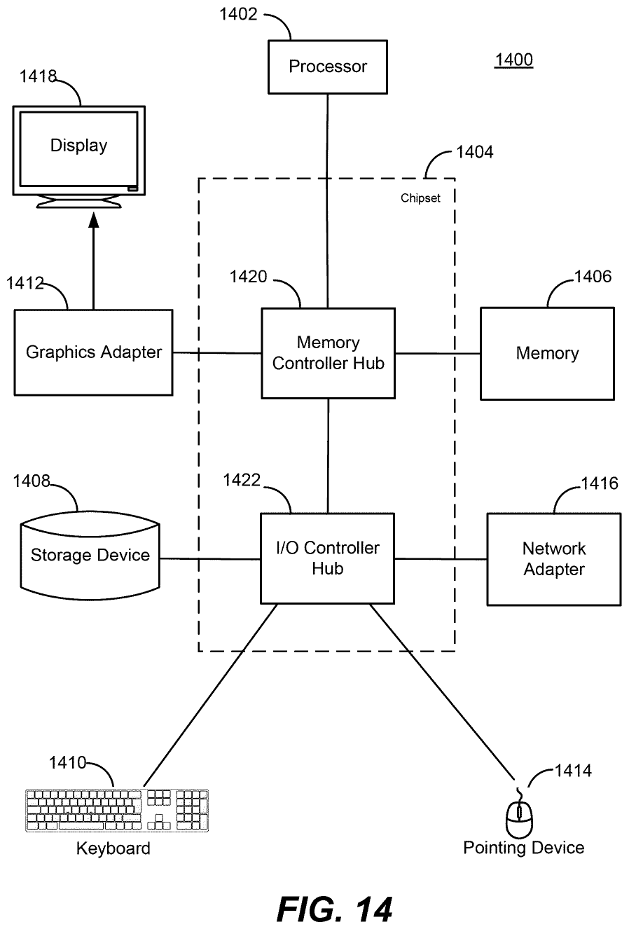

FIG. 14 is a block diagram of an example computer 1400 suitable for use in the networked computing environment 100 of FIG. 1. The computer 1400 is a computer system and is configured to perform specific functions as described herein. For example, the specific functions corresponding to the automation system 110, the central system 120, and/or the client device 130 may be configured through the computer 1400.

The example computer 1400 includes a processor system having one or more processors 1402 coupled to a chipset 1404. The chipset 1404 includes a memory controller hub 1420 and an input/output (I/O) controller hub 1422. A memory system having one or more memories 1406 and a graphics adapter 1412 are coupled to the memory controller hub 1420, and a display 1418 is coupled to the graphics adapter 1412. A storage device 1408, keyboard 1410, pointing device 1414, and network adapter 1416 are coupled to the I/O controller hub 1422. Other embodiments of the computer 1400 have different architectures.

In the embodiment shown in FIG. 14, the storage device 1408 is a non-transitory computer-readable storage medium such as a hard drive, compact disk read-only memory (CD-ROM), DVD, or a solid-state memory device. The memory 1406 holds instructions and data used by the processor 1402. The pointing device 1414 is a mouse, track ball, touchscreen, or other types of a pointing device and may be used in combination with the keyboard 1410 (which may be an on-screen keyboard) to input data into the computer 1400. The graphics adapter 1412 displays images and other information on the display 1418. The network adapter 1416 couples the computer 1400 to one or more computer networks, such as network 140.

The types of computers used by the enterprises of FIGS. 1 through 3 can vary depending upon the embodiment and the processing power required by the enterprise. For example, the central system 120 might include multiple blade servers working together to provide the functionality described. Furthermore, the computers can lack some of the components described above, such as keyboards 1410, graphics adapters 1412, and displays 1418.

### Additional Considerations

The foregoing description of the embodiments of the invention has been presented for the purpose of illustration; it is not intended to be exhaustive or to limit the invention to the precise forms disclosed. Persons skilled in the relevant art can appreciate that many modifications and variations are possible in light of the above disclosure.

Some portions of this description describe the embodiments of the invention in terms of algorithms and symbolic representations of operations on information. These algorithmic descriptions and representations are commonly used by those skilled in the data processing arts to convey the substance of their work effectively to others skilled in the art. These operations, while described functionally, computationally, or logically, are understood to be implemented by computer programs or equivalent electrical circuits, microcode, or the like. Furthermore, it has also proven convenient at times, to refer to these arrangements of operations as modules, without loss of generality. The described operations and their associated modules may be embodied in software, firmware, hardware, or any combinations thereof.

Any of the steps, operations, or processes described herein may be performed or implemented with one or more hardware or software modules, alone or in combination with other devices. In one embodiment, a software module is implemented with a computer program product comprising a computer-readable medium containing computer program code, which can be executed by a computer processor for performing any or all of the steps, operations, or processes described.

Embodiments of the invention may also relate to an apparatus for performing the operations herein. This apparatus may be specially constructed for the required purposes, and/or it may comprise a general-purpose computing device selectively activated or reconfigured by a computer program stored in the computer. Such a computer program may be stored in a tangible computer-readable storage medium, which includes any type of tangible media suitable for storing electronic instructions and coupled to a computer system bus. Furthermore, any computing systems referred to in the specification may include a single processor or may be architectures employing multiple processor designs for increased computing capability.

Embodiments of the invention may also relate to a computer data signal embodied in a carrier wave, where the computer data signal includes any embodiment of a computer program product or other data combination described herein. The computer data signal is a product that is presented in a tangible medium or carrier wave and modulated or otherwise encoded in the carrier wave, which is tangible, and transmitted according to any suitable transmission method.

Finally, the language used in the specification has been principally selected for readability and instructional purposes, and it may not have been selected to delineate or circumscribe the inventive subject matter. It is, therefore, intended that the scope of the invention be limited not by this detailed description but rather by any claims that issue on an application based hereon. Accordingly, the disclosure of the embodiments of the invention is intended to be illustrative, but not limiting, of the scope of the invention, which is set forth in the following claims.

What is claimed is:

1. A method comprising:
receiving a demonstration of a lab protocol for operating a type of machine from a user;
recording a sequence of actions associated with operating the type of machine based on the demonstration;
for each action in the sequence of actions, using computer vision to derive information associated with the action based on the recorded sequence of actions;
extracting semantic meanings of the action based in part on the information derived from the computer vision; and
generating a machine executable protocol for operating the type of machine by a robot based in part on the semantic meanings of the actions.

2. The method of claim 1, wherein the demonstration comprises that the user physically moves a robotic arm or an end effector of the robotic arm of the robot to operate a machine of the type.

3. The method of claim 2, wherein the demonstration comprises moving the robotic arm and the end effector to cause the end effector to press a button of the machine of the type.

4. The method of claim 2, wherein the demonstration comprises moving the robotic arm and the end effector to cause the end effector to grab an object from a location outside the machine of the type and place the object inside the machine of the type.

5. The method of claim 2, wherein the demonstration comprises moving the robotic arm and the end effector to cause the end effector to open a lid of the machine of the type.

6. The method of claim 2, wherein the machine is one or more of an incubator, a centrifuge, an imaging microscope, a thermocycler, a flow cytometer, a cell counter, an ultra-low-temperature (ULT) freezer, an automated tissue processor, or a spectrophotometer.

7. The method of claim 2, wherein recording the sequence of actions comprises:
recording a sequence of motions of the robotic arm; and
recording a sequence of images surrounding an end effector of the robotic arm.

8. The method of claim 2, wherein generating a machine-executable protocol comprises:
accessing a library of atomic actions that are executable by the robotic arm;
for each action in the sequence of actions, identifying one or more atomic actions from the library;
linking the one or more atomic actions corresponding to each action in the sequence to generate the machine-executable protocol.

9. A non-transitory computer-readable storage medium having instructions encoded thereon that, when executed by one or more processor, cause the one or more processors to perform actions comprising:
receiving a demonstration of a lab protocol for operating a type of machine from a user;
recording a sequence of actions associated with operating the type of machine based on the demonstration;
for each action in the sequence of actions, using computer vision to derive information associated with the action based on the recorded sequence of actions;
extracting semantic meanings of the action based in part on the information derived from the computer vision; and
generating a machine executable protocol for operating the type of machine by a robot based in part on the semantic meanings of the actions.

10. The non-transitory computer-readable storage medium of claim 9, wherein the demonstration comprises that the user physically moves a robotic arm or an end effector of the robotic arm of the robot to operate a machine of the type.

11. The non-transitory computer-readable storage medium of claim 10, wherein the demonstration comprises moving the robotic arm and the end effector to cause the end effector 220 to press a button of the machine of the type.

12. The non-transitory computer-readable storage medium of claim 10, wherein the demonstration comprises moving the robotic arm and the end effector to cause the end effector to grab an object from a location outside the machine of the type and place the object inside the machine of the type.

13. The non-transitory computer-readable storage medium of claim 10, wherein the demonstration comprises moving the robotic arm and the end effector to cause the end effector to open a lid of the machine of the type.

14. The non-transitory computer-readable storage medium of claim 10, wherein the machine is one or more of an incubator, a centrifuge, an imaging microscope, a thermocycler, a flow cytometer, a cell counter, an ultra-low-temperature (ULT) freezer, an automated tissue processor, or a spectrophotometer.

15. The non-transitory computer-readable storage medium of claim 10, wherein recording the sequence of actions comprises:
recording a sequence of motions of the robotic arm; and
recording a sequence of images surrounding an end effector of the robotic arm.

16. The non-transitory computer-readable storage medium of claim 10, wherein generating a machine-executable protocol comprises:
accessing a library of atomic actions that are executable by the robotic arm;
for each action in the sequence of actions, identifying one or more atomic actions from the library;
linking the one or more atomic actions corresponding to each action in the sequence to generate the machine-executable protocol.

17. An automation system comprising:
a robotic arm with an end effector;
an imaging sensor;
a processor;
a non-transitory computer-readable storage medium having instructions encoded thereon that, when executed by the processor, cause the automation system to:
receive a demonstration of a lab protocol for operating a type of machine by a user, the demonstration comprising that the user physically moves the robotic arm or the end effector to operate a machine of the type;
record a sequence of actions associated with operating the type of machine based on the demonstration, recording the sequence of actions comprising recording, by the imaging sensor, a sequence of images surrounding an end effector of the robotic arm;
for each action in the sequence of actions, use computer vision to derive information associated with the action based on the sequence of images;
extract semantic meanings of the action based in part on the information derived from the computer vision; and
generate a machine executable protocol for operating the type of machine by a robot based in part on the semantic meanings of the actions.

18. The automation system of claim 17, wherein the demonstration comprises that the user physically moves a robotic arm or an end effector of the robotic arm of the robot to operate a machine of the type.

19. The automation system of claim 18, wherein the demonstration comprises moving the robotic arm and the end effector to cause the end effector to press a button of the machine of the type.

20. The automation system of claim 18, wherein the demonstration comprises moving the robotic arm and the end effector to cause the end effector to grab an object from a location outside the machine of the type and place the object inside the machine of the type.
